(19) United States
(12) Patent Application Publication
(10) Pub. No.: US 2025/0065264 A1
(43) Pub. Date: Feb. 27, 2025

(54) FLUID CATALYTIC CRACKING OXY COMBUSTION GAS TREATMENT PROCESS

(71) Applicant: Honeywell International Inc., Charlotte, NC (US)

(72) Inventors: Elizabeth Jensen, Des Plaines, IL (US); William J. Whyman, Collinsville, OK (US); Alec A. Sheir, Tulsa, OK (US); Sakthievelan Maadasamy Durai, Haryana (IN)

(21) Appl. No.: 18/669,629

(22) Filed: May 21, 2024

Related U.S. Application Data
(60) Provisional application No. 63/520,800, filed on Aug. 21, 2023.

(51) Int. Cl. B01D 53/75; B01D 46/02; B01D 53/34; B01D 53/50; B01D 53/56; B01D 53/78; B01D 53/81; B01J 38/12; B03C 3/017

(52) U.S. Cl. CPC B01D 53/75; B01D 46/02; B01D 53/343; B01D 53/508; B01D 53/56; B01D 53/78; B01D 53/81; B01J 38/12; B03C 3/017; B01D 2251/2062; B01D 2251/2067; B01D 2251/604; B01D 2251/606; B01D 2258/0283

(57) ABSTRACT

Processes for regenerating catalyst from a fluidized catalytic process and purifying the flue gas are described. The process involves incorporating a combined quench/polishing column into the catalyst regeneration and flue gas purifying process. The combined quench/polishing column is located after the filtered dry SOx reactor effluent stream is cooled. The cooled effluent stream is quenched in the quench section of the combined quench/polishing column to form a quenched stream, and a second reactant is contacted with the quenched stream in the polishing section of the combined quench/polishing column to form a liquid stream and a purified outlet gas stream with a reduced temperature compared to the cooled effluent stream.

### RELATED APPLICATIONS

This application claims priority to U.S. Provisional Patent Application Ser. No. 63/520,800, filed on Aug. 21, 2023, the entirety of which is incorporated herein by reference.

Conventional treatment of flue gas from fluid catalytic cracking (FCC) units and fluidized bed dehydrogenation units involves the use of wet gas scrubbing technology, such as a caustic scrubber, to remove sulfur compounds from the flue gas. In this process, the flue gas from the FCC regenerator is heat exchanged with boiler feed water to make steam and cool the flue gas. The flue gas is further cooled from a temperature of 400-500° F. to a temperature of 140-194° F. using a water quench. The cooled flue gas is contacted with NaOH which reacts with the sulfur compounds to form Na₂SO₃ and/or Na₂SO₄ and water, which are removed. The flue gas can optionally be heated and treated to remove nitrogen compounds. The flue gas can also optionally be treated to remove catalyst fines and other particulate. The treated flue gas can then be discharged to the atmosphere.

However, the capital costs of the system are high, as are the operating costs due to the use of NaOH, water, electricity, flocculants, and slurry handling. Moreover, the system requires a large area and is maintenance intensive. The wet scrubber process has a high make-up water requirement due to water quenching and the use of aqueous NaOH. The system also suffers from corrosion problems related to the use of H₂SO₄, and spray nozzle fouling concerns due to the presence of salts. A substantial amount of sensible energy is not recovered because of SO₃ (acid) dew point limitations. The poor energy recovery is due to the high stack temperature and poor thermal profile (quench the boiler flue gas outlet to adiabatic saturation for allowing wet sulfur removal and in some cases subsequently reheating the flue gas to the needed Selective Catalytic Reduction (SCR) inlet temperature requirement to allow nitrogen (NOx) removal. This may result in a negative energy balance. Furthermore, there can be issues of H₂SO₄/SO₃ blue plumes caused by formed submicron aerosols (H₂SO₄) and white plumes caused by water condensation when flue gas is emitted to atmosphere. This can be avoided by heating of the stream, but that increases capital and operating costs.

Therefore, there is a need for improved processes for treating flue gas containing sulfur compounds.

### Definitions

As used herein, “NOₓ” refers to nitrogen containing compounds, including nitrogen oxides (NO) and nitrogen dioxides (NO₂). “SOₓ” refers to sulfur containing compounds, including sulfur dioxides (SO₂) and sulfur trioxides (SO₃). “VOC's” means volatile organic compounds that have a high vapor pressure and low water solubility, including industrial solvents such as trichloroethylene, fuel oxygenates such as methyl tert-butyl ether (MTBE). This list is not intended to be exhaustive, but merely exemplary. Additional “NOₓ”, “SOₓ”, and “VOC” compounds can be found, for example in the definitions provided by the EPA. Additionally, it should be understood that “NOₓ”, “SOₓ”, and “VOC's” also refers to the intermediate compounds that are produced during the regeneration process of the FCC. “Particulate Matter” refers to fine particulate.

“DSI” means dry sorbent injection.

“WGS” means a wet gas scrubber

### BRIEF DESCRIPTION OF THE DRAWINGS

FIG. 1 illustrates one embodiment of a gas treatment process for flue gas from a fluid catalytic cracking process unit with a one-stage dry sorbent injection (DSI) system and a combined quench/polishing column.

FIG. 2 illustrates one embodiment of a combined quench/polishing column.

### DESCRIPTION

The processes involve treating flue gas streams from a regenerator in FCC processes, as well as reducing the sulfur content of the flue gas stream and optionally the nitrogen content of the flue gas stream.

Generally, the process comprises: passing a mixture of a preheated CO₂ recycle stream and a concentrated oxygen stream to the regenerator to generate the flue gas stream comprising CO₂, CO, SOₓ, NOₓ, catalyst fines, O₂, and H₂O; transferring heat from the flue gas stream to a boiler feed water stream in a heat recovery section to form a partially cooled flue gas stream and a steam stream; reacting one or more of a sulfur-containing compound in the flue gas stream with a reactant and filtering the reaction product to form a reactor effluent flue gas stream and a contaminant stream, the reactor effluent gas stream having a level of the sulfur-containing compound less than a level of the sulfur-containing compound in the flue gas stream; heating a CO₂ recycle stream with the reactor effluent gas stream to produce the preheated CO₂ recycle stream and a cooled reactor effluent stream; and purifying the cooled reactor effluent stream to produce a CO₂ product stream and CO₂ recycle stream.

There is a combined quench/polishing column as part of the flue gas purification step. In this case, the cooled effluent stream is quenched in the quench section of the combined quench/polishing column to form a quenched stream before introducing the cooled effluent stream into the carbon capture section, and a second reactant is contacted with the quenched stream in the polishing section of the combined quench/polishing column to form a liquid stream and a purified outlet gas stream. The liquid stream comprises one or more of H₂O, Na₂SO₄, Na₂SO₄, NaHSO₃, Na₂CO₃, CaSO₄, CaCO₃, K₂SO₄, and K₂CO₃. The reactant comprises one or more of NaOH, KOH, CaOH, NaHCO₃, Na₂CO₃, NaHCO₃. Na₂CO₃·2(H₂O), CaCO₃ and Ca(OH)₂. The purified outlet gas stream is introduced into the carbon capture section.

In one embodiment, the process comprises: passing a mixture of a preheated CO₂ recycle stream and a concentrated oxygen stream to the regenerator to generate the flue gas stream comprising CO₂, CO, SOₓ, NOₓ, catalyst fines, O₂. N₂, and H₂O; transferring heat from the flue gas stream to a liquid process stream having a temperature less than a temperature of the flue gas stream in a heat recovery section to form a partially cooled flue gas stream and a steam stream; reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream; filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream; cooling the filtered dry SOₓ reactor effluent gas steam to provide a cooled reactor effluent stream; and introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream and a liquid waste stream comprising water, Na₂SO₃, and caustic solution.

The temperature in the combined quench/polishing column is typically in the range of 37° C. and 97° C., and the pressure is typically in the range of 75 kPa and 125 kPa.

In some embodiments, heat is recovered from the filtered dry SOₓ reactor effluent gas steam before cooling the filtered dry SOₓ reactor effluent gas stream. In some embodiments, recovering heat from the filtered dry SOₓ reactor effluent gas steam comprises pre-heating a process fluid stream with the filtered dry SOₓ reactor effluent stream.

In some embodiments, the cooled reactor effluent stream is further cooled and water is removed from the cooled reactor effluent stream before purifying the cooled reactor effluent stream.

In some embodiments, there is a NOₓ reactor section where nitrogen-containing compounds are reacted. The NOₓ reactor can be located before or after the SOₓ reactor and filtration section. The NOₓ reactor section may comprise a selective catalytic reduction (SCR) reactor to form a NOₓ reactor effluent stream with a reduced level of nitrogen-containing compounds compared to the incoming stream. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream is introduced into the NOₓ reactor section where it reacts with the NOₓ present in the incoming stream.

Any suitable caustic solution can be used. Suitable caustic solutions include, but are not limited to, an aqueous solution of NaOH, CaOH, NaHCO₃, Na₂CO₃, NaHCO₃·Na₂CO₃·2(H₂O), CaCO₃ and Ca(OH)₂, or combinations thereof.

The dry SOₓ reactor flue gas stream can be filtered using any suitable filtering system. Suitable filtering systems include, but are not limited to, bag filters or electrostatic precipitators.

The filtered dry SOₓ reactor effluent gas stream may be cooled using any suitable cooling method. Suitable cooling systems include, but are not limited to, cooling water heat exchangers, or ambient air-based cooling systems, or directly injecting ambient-temperature process water into the filtered dry SOₓ reactor effluent gas stream.

The combined quench/polishing column may comprise a liquid recirculation stream. In some embodiments, the liquid recirculation stream may be passed cooling system to subcool the liquid recirculation stream below a saturation point. The subcooled liquid recirculation stream may be introduced into the combined quench/polishing column. Any suitable cooling system can be used to subcool the liquid recirculation stream. Suitable cooling systems include, but are not limited to, an air cooling system or a heat exchanger. In some embodiments, the heat exchanger may use a cool vapor stream.

In some embodiments, the process includes passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, to cool the filtered dry SOₓ reactor effluent gas stream.

In some embodiments, the process further comprises recycling a portion of the CO₂ recycle stream through a compressor.

In some embodiments, the process further comprises: introducing the flue gas stream into a superheated steam section of a heat recovery steam generator (HRSG) before the decontamination reactor to produce a superheated steam stream and a partially cooled flue gas stream, the HRSG comprising the superheated steam section and a saturated steam section; introducing a boiler feed water stream and the partially cooled flue gas stream into the saturated steam section to produce a saturated steam stream and a second partially cooled flue gas stream; introducing at least a portion of the saturated steam stream into the superheated steam section; superheating the saturated steam stream with the flue gas stream to produce the superheated steam stream; and wherein reacting one or more of the sulfur-containing compound, the nitrogen-containing compound, or both in the flue gas stream with the reactant in the decontamination reactor comprises reacting one or more of the sulfur-containing compound, the nitrogen-containing compound, or both in the partially cooled flue gas stream with the reactant.

In some embodiments, the concentrated oxygen stream is made in an air separation unit or an electrolyzer.

In another embodiment, the process for regenerating catalyst from a fluidized catalytic process and purifying the flue gas comprises: passing a mixture of a preheated CO₂ recycle stream and a concentrated oxygen stream to the regenerator to generate the flue gas stream comprising CO₂, CO, SOₓ, NOₓ, catalyst fines, O₂. N₂, and H₂O; transferring heat from the flue gas stream to a liquid process stream having a temperature less than a temperature of the flue gas stream in a heat recovery section to form a partially cooled flue gas stream and a steam stream; reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream; filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream; recovering heat from the filtered dry SOₓ reactor effluent gas steam; cooling the filtered dry SOₓ reactor effluent gas steam after recovering heat from the filtered dry SOₓ reactor effluent gas steam to provide a cooled reactor effluent stream; introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream, a liquid recirculation stream, and a liquid waste stream comprising water, Na₂SO₃, and caustic solution; subcooling the liquid recirculation stream below a saturation point; and circulating the subcooled liquid recirculation stream within the combined quench/polishing column.

In some embodiments, subcooling the liquid recirculation stream below the saturation point comprises passing the liquid recirculation through an air cooling system, or passing the liquid recirculation stream through a heat exchanger utilizing a cool vapor stream, or passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, or combinations thereof.

In some embodiments, recovering heat from the filtered dry SOₓ reactor effluent gas steam comprises pre-heating a process fluid stream with the filtered dry SOₓ reactor effluent stream.

In some embodiments, filtering the dry SOₓ reactor flue gas stream comprises filtering the dry SOₓ reactor flue gas stream using a bag filter or an electrostatic precipitator.

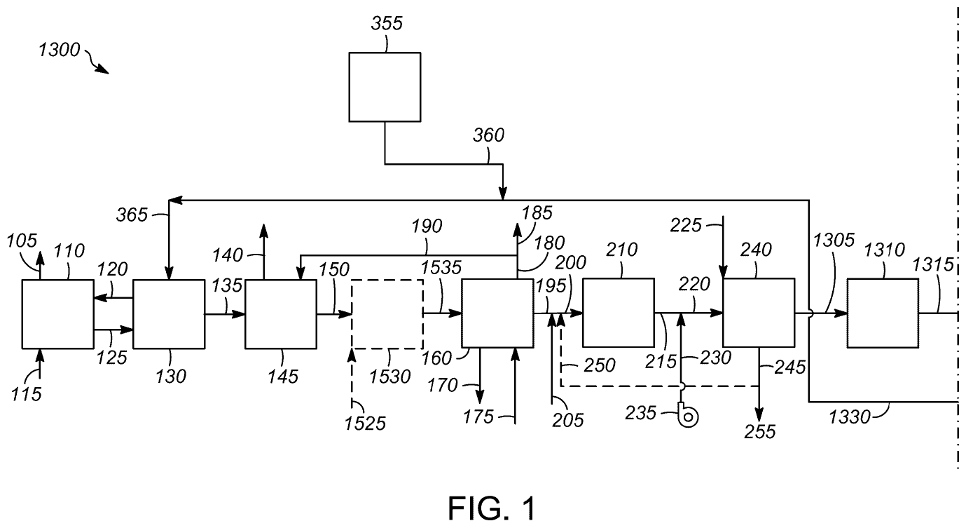

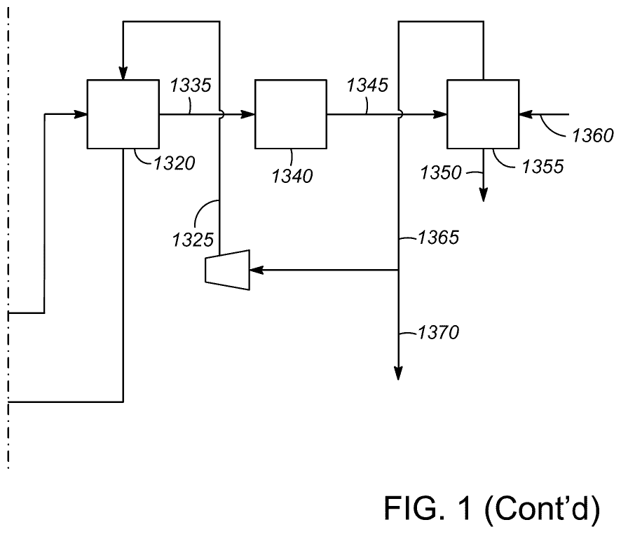

FIG. 1 illustrates one embodiment of a gas treatment process for flue gas from a fluid catalytic cracking process 1300 comprises of a FCC reactor 110, a regenerator 130, an air separation unit (ASU) or electrolyzer unit 355, and heat recovery steam generator (HRSG) 145 and 160, a dry sorbent injection (DSI) reactor 210, a filtration section 240, heat exchanger 1310, heat exchanger 1320, heat exchanger 1340, and a combined quench/polishing column 1355.

The feed stream 115 is sent to the FCC reactor 110 containing catalyst. The product is separated from the catalyst and the product containing stream 105 is sent for further processing.

The spent catalyst stream 125 is sent to the regenerator 130 where coke on the catalyst is burned to regenerate the catalyst. The regenerated catalyst 120 is returned to the FCC reactor 110.

Stream 365 containing a mixture of a preheated CO₂ recycle stream 1330 and a concentrated oxygen stream 360 is introduced into the regenerator 130. The concentrated oxygen stream 360 may be formed in an air separation unit (ASU) or an electrolyser unit 355. The concentrated oxygen stream 360 may have a concentration of 50 mol % oxygen or more, or 60 mol % or more, or 70 mol % or more, or 80 mol % or more, or 90 mol % or more, or 95 mol % or more, or 99 mol % or more, or 99.5 mol % or more, or 99.9 mol % or more.

The flue gas stream 135 comprises CO₂, CO, N₂, SOₓ, NOₓ, catalyst fines, O₂ and H₂O. The flue gas outlet temperature for the FCC regenerator 130 is in the range of about 650-815° C.

The flue gas stream 135 is then sent to the HRSG superheated steam unit 145 where it super heats a portion of 190 of the saturated steam 180 from the HRSG saturated steam unit 160 forming superheated steam stream 140 and a partially cooled flue gas stream 150.

In some embodiments, the NOₓ compounds are reacted in a NOₓ reaction section 1530 before the dry sorbent injection (DSI) reactor 210 between the HRSG superheated steam unit 145 and HRSG saturated steam unit 160. The NOₓ reaction section 1530 may comprise a selective catalytic reduction (SCR) reactor to form a NOₓ reactor effluent stream 1535 with a reduced level of nitrogen-containing compounds compared to the incoming partially cooled flue gas stream 150. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream 1525 is introduced into the NOₓ reactor section where it reacts with the NOₓ present in the incoming partially cooled flue gas stream 150. If a NOₓ reaction section is included, the effluent stream 1535 from the NOₓ reaction section 1530 contains a lower level of NOₓ compounds than the level of NOₓ compounds in the incoming partially cooled flue gas stream 150.

In some embodiments, the NOₓ reaction section 1530 is placed between the dry sorbent injection (DSI) reactor 210 and HRSG saturated steam unit 160. In some other embodiment, the NOₓ reaction section 1530 is integrated within the HRSG saturated steam unit 160. In some other embodiment, the NOₓ reaction section 1530 is placed after the first stage filtration section 240.

The partially cooled flue gas stream 150 (or 1535 if the NOₓ reaction section 1530 is present) is sent to the HRSG saturated steam unit 160. Boiler feed water stream 175 is heated by the partially cooled flue gas stream 150 (or 1530 if the NOₓ reaction section 1530 is present) forming saturated steam stream 180, blowdown stream 170 and a second partially cooled flue gas stream 195. A portion 190 of the saturated steam stream 180, is sent to the HRSG superheated steam unit 145. The remaining portion 185 of saturated steam stream 180, is sent to the other parts of the plant for use as needed.

The second partially cooled flue gas stream 195 from the HRSG saturated steam unit 160 is combined with a reactant stream 205 and in some cases a recycled sorbent stream 250 (comprising a mixture of at least one of CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), organic acids, heavy metals, catalyst fines, and fine particulate matter, depending on the compounds present in the flue gas and the reactant used, as discussed below) and sent to the DSI reactor 210 where the reactant reacts with the sulfur-containing compounds present in the combined partially cooled flue gas stream 200.

The inlet temperature for the DSI reactor 210 is typically in the range of 200° C.-400° C. with a pressure of −3 kPa (g) to 50 kPa (g). The outlet temperature for the DSI reactor 210 is typically in the range of 150° C.-400° C. with a pressure of −5 kPa (g) to 50 kPa (g). For example, the DSI reactor 210 may contain a reactant, such as at least one of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, and (Ca(OH)₂·(Mg(OH)₂). The reactant reacts with at least one of N₂, O₂, Cl₂, CO₂, H₂O, CO, NOₓ, SOₓ, fine particulate matter, catalyst fines, organic acids, heavy metals, dioxins, and furans in the incoming flue gas steam 200. The DSI reactor outlet 215 has a reduced content of at least one of the compounds compared to the incoming partially cooled flue gas steam 200.

The DSI reactor outlet stream 215 is combined with an optional quench stream 230 from quench air blower 235 in stream 220. The quench stream comprises air, and/or water, and/or quench flue gas. The quenched DSI reactor effluent stream 220 is sent to the first stage filtration section 240 for the removal of at least one of CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, catalyst fines, organic acids, heavy metals and fine particulate matter. The inlet temperature for the filtration section 240 is typically in the range of 150° C.-350° C. with a pressure of −5 kPa (g) to 50 kPa (g). The outlet temperature for the filtration section 240 is typically in the range of 150° C.-350° C. with a pressure of −7 kPa (g) to 50 kPa (g). The filtration section 240 comprises of a bag filter, and/or ceramic filter, and/or an electrostatic precipitator (ESP). An instrument air purge or high voltage DC 425 is introduced into the filtration section 240 through an instrument air or high voltage DC 425 stream 225. In the case of the instrument air purge, it purges the retained material from the filter. In the case of the high voltage stream, it charges the cathodes of the ESP. The particulate is removed from the ESP by vibration. Dry residue stream 245 comprising of at least one CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, NaHCO₃, Na₂CO₃, NaHCO₃·Na₂CO₃: 2 (H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), organic acids, heavy metals, catalyst fines, organic acids, heavy metals, and fine particulate matter exits the first stage filtration section 240. Alternatively, or additionally, a portion of the filtered material 245 can be recycled to the DSI reactor 210 by way of recycled sorbent stream 250 to increase the conversion yield of the reactant (i.e. from 85 wt % to 98 wt %). In the case where there is a recycled sorbent stream 250 of the filtered material 245, a portion 255 of the filtered material stream 245 can be removed from the process.

The filtered DSI reactor effluent stream 1305 may optionally be sent to a heat exchanger 1310 to recover heat and to form cooled reactor effluent stream 1315.

The filtered DSI reactor effluent stream 1305 (or reactor effluent stream 1315 if the optional heat exchanger 1310 is present) is sent to heat exchanger 1320 where it is heat exchanged with CO₂ recycle stream 1325 to form the preheated CO₂ recycle stream 1330 and a cooled reactor effluent stream 1335.

The cooled reactor effluent stream 1335 may be sent to an optional heat exchanger 1340 to further cool and condense it forming cooled reactor effluent stream 1345.

The cooled reactor effluent stream 1335 (or cooled reactor effluent stream 1345 if the optional heat exchanger 1340 is present) is sent to a combined quench/polishing column 1355 to react the remaining sulfur containing compounds. The cooled reactor effluent stream 1335 (or cooled reactor effluent stream 1345 if the optional heat exchanger 1340 is present) is quenched and reacted with the aqueous caustic solution stream 1360 forming a liquid brine stream 1350 and a purified outlet gas stream 1365 with a sulfur concentration less than the inlet cooled reactor effluent stream 1335 (or cooled reactor effluent stream 1345 if the optional heat exchanger 1340 is present). The liquid brine stream 1350 comprises one or more of H₂O, Na₂SO₄, Na₂SO₄, NaHSO₃, Na₂CO₃, CaSO₄, CaCO₃, K₂SO₄, and K₂CO₃. The aqueous caustic solution 1360 comprises one or more of NaOH, KOH, CaOH, NaHCO₃, Na₂CO₃, NaHCO₃·Na₂CO₃·2(H₂O), CaCO₃ and Ca(OH)₂.

Part of the purified outlet gas stream 1365 is separated as CO₂ recycle stream 1325 which is passed to the heat exchanger 1320. The rest of the purified outlet gas stream 1365 is taken out as product gas stream 1370.

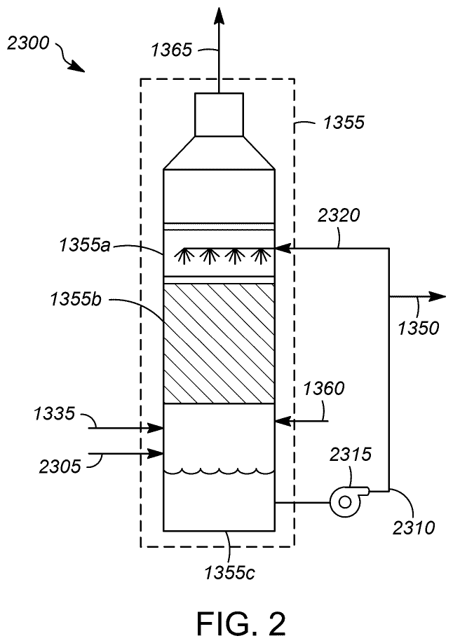

FIG. 2 provides an illustration of one embodiment of a combined quench/polishing column 2300.

The cooled reactor effluent stream 1335 and make-up water stream 2305 are sent to an optional combined quench polishing column 1355 where the temperature of the flue gas is reduced to the saturation temperature using an aqueous caustic solution where it will react with at least one of SOₓ, HCl and Cl₂ in the cooled reactor effluent stream 1335. The combined quench/polishing column 1355 consists of a packed caustic scrubber (1355b), a spray contractor (1355a), and a quench tank (1355c). The inlet temperature for the quench polishing column 1355 is typically in the range of 45° C.-150° C. with a pressure of −12 kPa (g) to 50 kPa (g). The outlet temperature for the quench polishing column 1355 is typically in the range of 45° C.-75° C. with a pressure of −15 kPa (g) to 50 kPa (g). An injection of an aqueous caustic solution 1360 enters column 1355 below the packed caustic scrubber section 1355b. Stream 1360 includes, but is not limited to, water, air, recycle flue gas, caustic or combinations thereof. A stream exits at the bottom column 1355, from the quench tank 1355c, and is directed to the quench pumps 2315. Part of the recirculating liquid stream 2310 from the quench pumps 2315 exits the system as a brine solution 1350 while the rest is sent to the contactor spray nozzles. An aqueous brine solution stream 1350 containing at least one of CaSO₄, CaSO₃, H₂O, CaCl₂), CaF, CaF₂, CaCO₃, Ca(HSO₃), Na₂CO₃, NaCl, CO₂, Na₂SO₃, Na₂SO₄, Na₂NO₃, NaCl, NaF, K₂SO₃, K₂SO₄, K₂CO₃, KNO₃, KCl, KF, MgCl₂, MgCO₃, MgSO₄, CaSO₄·2(H₂O), Mg(NO₃)₂, Catalyst Fines, organic acids, heavy metals and Fine Particulate Matter exits the combined quench polishing column 1355. If desired, a reducing agent such as NaHSO₃ or H₂O₂, can be included to react with the Cl₂ to form HCl which reacts to form NaCl. The quench polishing column outlet flue gas stream 1365 has a reduced level of at least one of SOₓ, HCl and Cl₂ compared to the incoming quenched flue gas stream 1335. The purified outlet gas stream 1365 is separated as CO₂ recycle stream 1325 which is passed to the heat exchanger 1320. The rest of the purified outlet gas stream 1365 is taken out as product gas stream 1370.

### Specific Embodiments

While the following is described in conjunction with specific embodiments, it will be understood that this description is intended to illustrate and not limit the scope of the preceding description and the appended claims.

A first embodiment of the invention is a process for regenerating catalyst from a fluidized catalytic process and purifying the flue gas comprising passing a mixture of a preheated CO₂ recycle stream and a concentrated oxygen stream to the regenerator to generate the flue gas stream comprising CO₂, CO, SOₓ, NOₓ, catalyst fines, O₂. N₂, and H₂O; transferring heat from the flue gas stream to a liquid process stream having a temperature less than a temperature of the flue gas stream in a heat recovery section to form a partially cooled flue gas stream and a steam stream; reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream; filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream; cooling the filtered dry SOₓ reactor effluent gas steam to provide a cooled reactor effluent stream; introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream and a liquid waste stream comprising water, Na₂SO₃, and caustic solution. An embodiment of the invention is one, any or all of prior embodiments in this paragraph up through the first embodiment in this paragraph further comprising recovering heat from the filtered dry SOₓ reactor effluent gas steam before cooling the filtered dry SOₓ reactor effluent gas stream. An embodiment of the invention is one, any or all of prior embodiments in this paragraph up through the first embodiment in this paragraph wherein recovering heat from the filtered dry SOₓ reactor effluent gas steam comprises pre-heating a process fluid stream with the filtered dry SOₓ reactor effluent stream. An embodiment of the invention is one, any or all of prior embodiments in this paragraph up through the first embodiment in this paragraph further comprising reacting one or more of a nitrogen-containing compound in the filtered dry SOₓ reactor effluent gas stream with ammonia or urea in a NOₓ reactor to form a NOₓ reactor effluent stream having a level of the nitrogen-containing compound less than a level of the nitrogen-containing compound in the filtered dry SOₓ reactor effluent gas stream. An embodiment of the invention is one, any or all of prior embodiments in this paragraph up through the first embodiment in this paragraph further comprising reacting one or more of a nitrogen-containing compound in the partially cooled flue gas stream with ammonia or urea in a NOₓ reactor to form a NOₓ reactor effluent stream before reacting one or more of the sulfur-containing compound in the partially cooled flue gas stream with the reactant, wherein the NOₓ reactor effluent stream has a level of the nitrogen-containing compound less than a level of the nitrogen-containing compound in the partially cooled flue gas stream. An embodiment of the invention is one, any or all of prior embodiments in this paragraph up through the first embodiment in this paragraph wherein the caustic solution comprises an aqueous solution of NaOH, CaOH, NaHCO₃, Na₂CO₃, NaHCO₃·Na₂CO₃·2(H₂O), CaCO₃ and Ca(OH)₂, or combinations thereof. An embodiment of the invention is one, any or all of prior embodiments in this paragraph up through the first embodiment in this paragraph wherein cooling the filtered dry SOₓ reactor effluent gas steam comprises using a cooling water heat exchanger, or using an ambient air-based cooling system, or directly injecting ambient-temperature process water into the filtered dry SOₓ reactor effluent gas stream. An embodiment of the invention is one, any or all of prior embodiments in this paragraph up through the first embodiment in this paragraph wherein the combined quench/polishing column further comprises a liquid recirculation stream, the process further comprising passing the liquid recirculation stream through an air cooling system to subcool the liquid recirculation stream below a saturation point. An embodiment of the invention is one, any or all of prior embodiments in this paragraph up through the first embodiment in this paragraph wherein the combined quench/polishing column further comprises a liquid recirculation stream, the process further comprising passing the liquid recirculation stream through a heat exchanger utilizing a cool vapor stream to subcool the liquid recirculation stream below a saturation point; and introducing the subcooled liquid recirculation stream to the combined quench/polishing column. An embodiment of the invention is one, any or all of prior embodiments in this paragraph up through the first embodiment in this paragraph further comprising passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, to cool the filtered dry SOₓ reactor effluent gas stream. An embodiment of the invention is one, any or all of prior embodiments in this paragraph up through the first embodiment in this paragraph wherein filtering the dry SOₓ reactor flue gas stream comprises filtering the dry SOₓ reactor flue gas stream using a bag filter or an electrostatic precipitator. An embodiment of the invention is one, any or all of prior embodiments in this paragraph up through the first embodiment in this paragraph further comprising dividing the filtered material stream into two portions; recycling a first portion to the dry SOₓ reactor; and recovering the second portion. An embodiment of the invention is one, any or all of prior embodiments in this paragraph up through the first embodiment in this paragraph further comprising compressing a portion of the purified cooled reactor effluent vapor stream from the combined quench/polishing column. An embodiment of the invention is one, any or all of prior embodiments in this paragraph up through the first embodiment in this paragraph wherein a temperature in the combined quench/polishing column is in a range of 37° C. and 97° C. An embodiment of the invention is one, any or all of prior embodiments in this paragraph up through the first embodiment in this paragraph wherein a pressure in the combined quench/polishing column is in a range of 75 kPa and 125 kPa. An embodiment of the invention is one, any or all of prior embodiments in this paragraph up through the first embodiment in this paragraph wherein the heat recovery section comprises a heat recovery steam generator (HRSG) comprising a superheated steam section and a saturated steam section, and wherein transferring heat from the flue gas stream to the boiler feed water stream comprises introducing the flue gas stream into the superheated steam section to produce a superheated steam stream and a partially cooled flue gas stream; introducing the boiler feed water stream and the partially cooled flue gas stream into the saturated steam section to produce a saturated steam stream; introducing at least a portion of the saturated steam stream into the superheated steam section; and superheating the saturated steam stream with the flue gas stream to produce the superheated steam stream.

A second embodiment of the invention is a process for regenerating catalyst from a fluidized catalytic process and purifying the flue gas comprising passing a mixture of a preheated CO₂ recycle stream and a concentrated oxygen stream to the regenerator to generate the flue gas stream comprising CO₂, CO, SOₓ, NOₓ, catalyst fines, O₂. N₂, and H₂O; transferring heat from the flue gas stream to a liquid process stream having a temperature less than a temperature of the flue gas stream in a heat recovery section to form a partially cooled flue gas stream and a steam stream; reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream; filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream; recovering heat from the filtered dry SOₓ reactor effluent gas steam; cooling the filtered dry SOₓ reactor effluent gas steam after recovering heat from the filtered dry SOₓ reactor effluent gas steam to provide a cooled reactor effluent stream; introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream, a liquid recirculation stream, and a liquid waste stream comprising water, Na₂SO₃, and caustic solution; subcooling the liquid recirculation stream below a saturation point; and circulating the subcooled liquid recirculation stream within the combined quench/polishing column. An embodiment of the invention is one, any or all of prior embodiments in this paragraph up through the second embodiment in this paragraph wherein subcooling the liquid recirculation stream below the saturation point comprises passing the liquid recirculation through an air cooling system, or passing the liquid recirculation stream through a heat exchanger utilizing a cool vapor stream, or passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, or combinations thereof. An embodiment of the invention is one, any or all of prior embodiments in this paragraph up through the second embodiment in this paragraph wherein recovering heat from the filtered dry SOₓ reactor effluent gas steam comprises pre-heating a process fluid stream with the filtered dry SOₓ reactor effluent stream. An embodiment of the invention is one, any or all of prior embodiments in this paragraph up through the second embodiment in this paragraph wherein filtering the dry SOₓ reactor flue gas stream comprises filtering the dry SOₓ reactor flue gas stream using a bag filter or an electrostatic precipitator.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

### Specific Embodiments

While the following is described in conjunction with specific embodiments, it will be understood that this description is intended to illustrate and not limit the scope of the preceding description and the appended claims.

A first embodiment of the invention is a process for regenerating catalyst from a fluidized catalytic process and purifying the flue gas comprising passing a mixture of a preheated CO₂ recycle stream and a concentrated oxygen stream to the regenerator to generate the flue gas stream comprising CO₂, CO, SOₓ, NOₓ, catalyst fines, O₂. N₂, and H₂O; transferring heat from the flue gas stream to a liquid process stream having a temperature less than a temperature of the flue gas stream in a heat recovery section to form a partially cooled flue gas stream and a steam stream; reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream; filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream; cooling the filtered dry SOₓ reactor effluent gas steam to provide a cooled reactor effluent stream; and introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream and a liquid waste stream comprising water, Na₂SO₃, and caustic solution. An embodiment of the invention is one, any or all of prior embodiments in this paragraph up through the first embodiment in this paragraph further comprising recovering heat from the filtered dry SOₓ reactor effluent gas steam before cooling the filtered dry SOₓ reactor effluent gas stream. An embodiment of the invention is one, any or all of prior embodiments in this paragraph up through the first embodiment in this paragraph wherein recovering heat from the filtered dry SOₓ reactor effluent gas steam comprises pre-heating a process fluid stream with the filtered dry SOₓ reactor effluent stream. An embodiment of the invention is one, any or all of prior embodiments in this paragraph up through the first embodiment in this paragraph further comprising reacting one or more of a nitrogen-containing compound in the filtered dry SOₓ reactor effluent gas stream with ammonia or urea in a NOₓ reactor to form a NOₓ reactor effluent stream having a level of the nitrogen-containing compound less than a level of the nitrogen-containing compound in the filtered dry SOₓ reactor effluent gas stream. An embodiment of the invention is one, any or all of prior embodiments in this paragraph up through the first embodiment in this paragraph further comprising reacting one or more of a nitrogen-containing compound in the partially cooled flue gas stream with ammonia or urea in a NOₓ reactor to form a NOₓ reactor effluent stream before reacting one or more of the sulfur-containing compound in the partially cooled flue gas stream with the reactant, wherein the NOₓ reactor effluent stream has a level of the nitrogen-containing compound less than a level of the nitrogen-containing compound in the partially cooled flue gas stream. An embodiment of the invention is one, any or all of prior embodiments in this paragraph up through the first embodiment in this paragraph wherein the caustic solution comprises an aqueous solution of NaOH, CaOH, NaHCO₃, Na₂CO₃, NaHCO₃·Na₂CO₃·2(H₂O), CaCO; and Ca(OH)₂, or combinations thereof. An embodiment of the invention is one, any or all of prior embodiments in this paragraph up through the first embodiment in this paragraph wherein cooling the filtered dry SOₓ reactor effluent gas steam comprises using a cooling water heat exchanger, or using an ambient air-based cooling system, or directly injecting ambient-temperature process water into the filtered dry SOₓ reactor effluent gas stream. An embodiment of the invention is one, any or all of prior embodiments in this paragraph up through the first embodiment in this paragraph wherein the combined quench/polishing column further comprises a liquid recirculation stream, the process further comprising passing the liquid recirculation stream through an air cooling system to subcool the liquid recirculation stream below a saturation point. An embodiment of the invention is one, any or all of prior embodiments in this paragraph up through the first embodiment in this paragraph wherein the combined quench/polishing column further comprises a liquid recirculation stream, the process further comprising passing the liquid recirculation stream through a heat exchanger utilizing a cool vapor stream to subcool the liquid recirculation stream below a saturation point; and introducing the subcooled liquid recirculation stream into the combined quench/polishing column. An embodiment of the invention is one, any or all of prior embodiments in this paragraph up through the first embodiment in this paragraph further comprising passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, to cool the filtered dry SOₓ reactor effluent gas stream. An embodiment of the invention is one, any or all of prior embodiments in this paragraph up through the first embodiment in this paragraph wherein filtering the dry SOₓ reactor flue gas stream comprises filtering the dry SOₓ reactor flue gas stream using a bag filter or an electrostatic precipitator. An embodiment of the invention is one, any or all of prior embodiments in this paragraph up through the first embodiment in this paragraph further comprising dividing the filtered material stream into two portions; recycling a first portion to the dry SOₓ reactor; and recovering the second portion. An embodiment of the invention is one, any or all of prior embodiments in this paragraph up through the first embodiment in this paragraph further comprising compressing and recycling a portion of the purified cooled reactor effluent vapor stream from the combined quench/polishing column to a regenerator. An embodiment of the invention is one, any or all of prior embodiments in this paragraph up through the first embodiment in this paragraph wherein a temperature in the combined quench/polishing column is in a range of 37° C. and 97° C. An embodiment of the invention is one, any or all of prior embodiments in this paragraph up through the first embodiment in this paragraph wherein a pressure in the combined quench/polishing column is in a range of 75 kPa and 125 kPa. An embodiment of the invention is one, any or all of prior embodiments in this paragraph up through the first embodiment in this paragraph wherein the heat recovery section comprises a heat recovery steam generator (HRSG) comprising a superheated steam section and a saturated steam section, and wherein transferring heat from the flue gas stream to the boiler feed water stream comprises introducing the flue gas stream into the superheated steam section to produce a superheated steam stream and a partially cooled flue gas stream; introducing the boiler feed water stream and the partially cooled flue gas stream into the saturated steam section to produce a saturated steam stream; introducing at least a portion of the saturated steam stream into the superheated steam section; and superheating the saturated steam stream with the flue gas stream to produce the superheated steam stream.

A second embodiment of the invention is a process for regenerating catalyst from a fluidized catalytic process and purifying the flue gas comprising passing a mixture of a preheated CO₂ recycle stream and a concentrated oxygen stream to the regenerator to generate the flue gas stream comprising CO₂, CO, SOₓ, NOₓ, catalyst fines, O₂, N₂, and H₂O; transferring heat from the flue gas stream to a liquid process stream having a temperature less than a temperature of the flue gas stream in a heat recovery section to form a partially cooled flue gas stream and a steam stream; reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream; filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream; recovering heat from the filtered dry SOₓ reactor effluent gas steam; cooling the filtered dry SOₓ reactor effluent gas steam after recovering heat from the filtered dry SOₓ reactor effluent gas steam to provide a cooled reactor effluent stream; introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream, a liquid recirculation stream, and a liquid waste stream comprising water, Na₂SO₃, and caustic solution; subcooling the liquid recirculation stream below a saturation point; and circulating the subcooled liquid recirculation stream within the combined quench/polishing column. An embodiment of the invention is one, any or all of prior embodiments in this paragraph up through the second embodiment in this paragraph wherein subcooling the liquid recirculation stream below the saturation point comprises passing the liquid recirculation through an air cooling system, or passing the liquid recirculation stream through a heat exchanger utilizing a cool vapor stream, or passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, or combinations thereof. An embodiment of the invention is one, any or all of prior embodiments in this paragraph up through the second embodiment in this paragraph wherein recovering heat from the filtered dry SOₓ reactor effluent gas steam comprises pre-heating a process fluid stream with the filtered dry SOₓ reactor effluent stream. An embodiment of the invention is one, any or all of prior embodiments in this paragraph up through the second embodiment in this paragraph wherein filtering the dry SOₓ reactor flue gas stream comprises filtering the dry SOₓ reactor flue gas stream using a bag filter or an electrostatic precipitator.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for regenerating catalyst from a fluidized catalytic process and purifying the flue gas comprising:
passing a mixture of a preheated CO₂ recycle stream and a concentrated oxygen stream to the regenerator to generate the flue gas stream comprising CO₂, CO, SOₓ, NOₓ, catalyst fines, O₂, N₂, and H₂O;
transferring heat from the flue gas stream to a liquid process stream having a temperature less than a temperature of the flue gas stream in a heat recovery section to form a partially cooled flue gas stream and a steam stream;
reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream;
filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream;
cooling the filtered dry SOₓ reactor effluent gas steam to provide a cooled reactor effluent stream; and
introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream and a liquid waste stream comprising water, Na₂SO₃, and caustic solution.

2. The process of claim 1 further comprising:
recovering heat from the filtered dry SOₓ reactor effluent gas steam before cooling the filtered dry SOₓ reactor effluent gas stream.

3. The process of claim 2 wherein recovering heat from the filtered dry SOₓ reactor effluent gas steam comprises pre-heating a process fluid stream with the filtered dry SOₓ reactor effluent stream.

4. The process of claim 1 further comprising:
reacting one or more of a nitrogen-containing compound in the filtered dry SOₓ reactor effluent gas stream with ammonia or urea in a NOₓ reactor to form a NOₓ reactor effluent stream having a level of the nitrogen-containing compound less than a level of the nitrogen-containing compound in the filtered dry SOₓ reactor effluent gas stream.

5. The process of claim 1 further comprising:
reacting one or more of a nitrogen-containing compound in the partially cooled flue gas stream with ammonia or urea in a NOₓ reactor to form a NOₓ reactor effluent stream before reacting one or more of the sulfur-containing compound in the partially cooled flue gas stream with the reactant, wherein the NOₓ reactor effluent stream has a level of the nitrogen-containing compound less than a level of the nitrogen-containing compound in the partially cooled flue gas stream.

6. The process of claim 1 wherein the caustic solution comprises an aqueous solution of NaOH, CaOH, NaHCO₃, Na₂CO₃, NaHCO₃·Na₂CO₃·2(H₂O), CaCO₃ and Ca(OH)₂, or combinations thereof.

7. The process of claim 1 wherein cooling the filtered dry SOₓ reactor effluent gas steam comprises using a cooling water heat exchanger, or using an ambient air-based cooling system, or directly injecting ambient-temperature process water into the filtered dry SOₓ reactor effluent gas stream.

8. The process of claim 1 wherein the combined quench/polishing column further comprises a liquid recirculation stream, the process further comprising:
passing the liquid recirculation stream through an air cooling system to subcool the liquid recirculation stream below a saturation point.

9. The process of claim 1 wherein the combined quench/polishing column further comprises a liquid recirculation stream, the process further comprising:
passing the liquid recirculation stream through a heat exchanger utilizing a cool vapor stream to subcool the liquid recirculation stream below a saturation point; and
introducing the subcooled liquid recirculation stream into the combined quench/polishing column.

10. The process of claim 1 further comprising:
passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, to cool the filtered dry SOₓ reactor effluent gas stream.

11. The process of claim 1 wherein filtering the dry SOₓ reactor flue gas stream comprises filtering the dry SOₓ reactor flue gas stream using a bag filter or an electrostatic precipitator.

12. The process of claim 1 further comprising:
dividing the filtered material stream into two portions;
recycling a first portion to the dry SOₓ reactor; and
recovering the second portion.

13. The process of claim 1 further comprising:
compressing and recycling a portion of the purified cooled reactor effluent vapor stream from the combined quench/polishing column to a regenerator.

14. The process of claim 1 wherein a temperature in the combined quench/polishing column is in a range of 37° C. and 97° C.

15. The process of claim 1 wherein a pressure in the combined quench/polishing column is in a range of 75 kPa and 125 kPa.

16. The process of claim 1 wherein the heat recovery section comprises a heat recovery steam generator (HRSG) comprising a superheated steam section and a saturated steam section, and wherein transferring heat from the flue gas stream to the boiler feed water stream comprises:
introducing the flue gas stream into the superheated steam section to produce a superheated steam stream and a partially cooled flue gas stream;
introducing the boiler feed water stream and the partially cooled flue gas stream into the saturated steam section to produce a saturated steam stream;
introducing at least a portion of the saturated steam stream into the superheated steam section; and
superheating the saturated steam stream with the flue gas stream to produce the superheated steam stream.

17. A process for regenerating catalyst from a fluidized catalytic process and purifying the flue gas comprising:
passing a mixture of a preheated CO₂ recycle stream and a concentrated oxygen stream to the regenerator to generate the flue gas stream comprising CO₂, CO, SOₓ, NOₓ, catalyst fines, O₂, N₂, and H₂O;
transferring heat from the flue gas stream to a liquid process stream having a temperature less than a temperature of the flue gas stream in a heat recovery section to form a partially cooled flue gas stream and a steam stream;
reacting one or more of a sulfur-containing compound in the partially cooled flue gas stream with a reactant in a single dry SOₓ reactor to form a dry SOₓ reactor flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOₓ, wherein the reactant comprises at least one of NaHCO₃, NaHCO₃·Na₂CO₃·2(H₂O), CaCO₃, Ca(OH)₂, and Mg(OH)₂; to form a reactor effluent flue gas stream and a contaminant stream;
filtering the dry SOₓ reactor flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form a filtered dry SOₓ reactor effluent gas stream and a filtered material stream, wherein the filtered dry SOₓ reactor effluent gas stream has a level of the sulfur-containing compound less than a level of the sulfur-containing compound in the partially cooled flue gas stream;
recovering heat from the filtered dry SOₓ reactor effluent gas steam;
cooling the filtered dry SOₓ reactor effluent gas steam after recovering heat from the filtered dry SOₓ reactor effluent gas steam to provide a cooled reactor effluent stream; introducing the cooled reactor effluent stream and a caustic solution to a combined quench/polishing column, further cooling the cooled reactor effluent stream to a saturation point, and further reducing the level of sulfur-containing compounds, forming a purified cooled reactor effluent vapor stream, a liquid recirculation stream, and a liquid waste stream comprising water, Na₂SO₃, and caustic solution;
subcooling the liquid recirculation stream below a saturation point; and
circulating the subcooled liquid recirculation stream within the combined quench/polishing column.

18. The process of claim 17 wherein subcooling the liquid recirculation stream below the saturation point comprises passing the liquid recirculation through an air cooling system, or passing the liquid recirculation stream through a heat exchanger utilizing a cool vapor stream, or passing the purified cooled reactor effluent through a first side of a heat exchanger and the filtered dry SOₓ reactor effluent gas stream through a second side of the heat exchanger to transfer heat from the filtered dry SOₓ reactor effluent gas stream to the purified cooled reactor effluent vapor stream, or combinations thereof.

19. The process of claim 17 wherein recovering heat from the filtered dry SOₓ reactor effluent gas steam comprises pre-heating a process fluid stream with the filtered dry SOₓ reactor effluent stream.

20. The process of claim 17 wherein filtering the dry SOₓ reactor flue gas stream comprises filtering the dry SOₓ reactor flue gas stream using a bag filter or an electrostatic precipitator.
